(19) United States
(12) Patent Application Publication
(10) Pub. No.: US 2009/0179496 A1
(43) Pub. Date: Jul. 16, 2009

(54) Power saving uninterruptible power supply

(75) Inventors: Lien-Hsun Ho, Taipei (TW); Shou-Ting Yeh, Taipei (TW); Hung-Ming Hsieh, Taipei (TW)

Correspondence Address: COOPER & DUNHAM, LLP, 30 Rockefeller Plaza, 20th Floor, NEW YORK, NY, 10112, US

(73) Assignee: Cyber Power System Inc.

(21) Appl. No.: 12/008,936

(22) Filed: Jan. 15, 2008

(51) Int. Cl. H02J 9/06; H02J 7/00

(52) U.S. Cl. 307/66; 320/134

(57) ABSTRACT

The power saving uninterruptible power supply (UPS) has a transformer, an automatic voltage regulator (AVR), a charger-and-inverter, a normal mode determination unit and an electric switch. The transformer has a primary side and a secondary side. The primary side is coupled to an alternating current (AC) power source. An AC input terminal of the AVR is coupled to the secondary side of the transformer to acquire an inducted AC power source to regulate the inducted AC power source to output to a load. The charger-and-inverter is coupled to the secondary side of the transformer to acquire a recharged power source to convert to a recharged current. The normal mode determination unit is coupled to the AC power source and the battery to detect a power supply status of the AC power source and battery capacity, so as to further determine whether current operation is normal.

### BACKGROUND OF THE INVENTION

1. Field of the Invention

The invention relates in general to an uninterruptible power supply (UPS), and more particularly to a power saving UPS that has low power consumption.

2. Description of the Related Art

With reference to FIG. 3, a conventional uninterruptible power supply (UPS) has a transformer 60, an automatic voltage regulator (AVR) 70 and a charger and inverter 80.

The transformer 60 has a primary side 61 and a secondary side 62. The primary side 11 is coupled to an alternating current (AC) power source.

An alternating current (AC) input terminal of the AVR 70 is coupled to the secondary side 62 of the transformer 60 to acquire an inducted AC power source. Then the AVR 70 regulates the inducted AC power source to output to a load 71.

The charger-and-inverter 80 is coupled to the secondary side 62 of the transformer 60 to acquire a recharged power source to convert to a recharged current. Then the charger-and-inverter 80 charges a battery 81 or also converts electricity of the battery 81 to the AC power source to output to the transformer 60. Then the AVR 70 regulates the AC power source to provide to the load 71 for emergency power supply.

When the UPS is coupled to the AC power source, the load 71 and the battery 80, the required power for the load 71 and the battery 81 are provided via the transformer 60. If the power supply status of the AC power source is normal and a battery capacity of the battery 81 is full, the AVR 70 acquires the AC power source via the transformer 80 to output to the load 71. The power consumption of the transformer 60 is very high and the size of the transformer 60 is also very large in order to be used for the AVR 70 and the charger-and-inverter 80. In the aforesaid operation mode, the power only supplies the AVR 70. Hence the overall efficiency of the transformer 60 consumes 50% of the power, which wastes power.

Moreover, the UPS is mainly used as the emergency power supply when the AC power source is not available. However, the abnormal AC power supply time is usually much shorter than the normal AC power supply time. From a viewpoint of long term usage, the conventional UPS over-consumes power and can be further improved.

### SUMMARY OF THE INVENTION

An objective of the present invention is to provide a power saving uninterruptible power supply (UPS). The power saving uninterruptible power supply (UPS) in accordance with the present invention not only provides emergency power supply, but also effectively resolves the drawback of over-consuming power.

The UPS has a transformer, an automatic voltage regulator (AVR), a charger and inverter, a normal mode determination unit and an electric switch.

The transformer has a primary side and a secondary side. The primary side is coupled to an alternating current (AC) power source.

An alternating current (AC) input terminal of the AVR is coupled to the secondary side of the transformer to acquire an inducted AC power source, then the AVR regulates the inducted AC power source to output to a load.

The charger-and-inverter is coupled to the secondary side of the transformer to acquire a recharged power source to convert to a recharged current, and then the charger-and-inverter charges a battery.

The normal mode determination unit is coupled to the AC power source and the battery to detect a power supply status of the AC power source and a battery capacity, so as to further determine whether current operation is in a normal mode.

The electric switch is connected in serial to the load and a power circuit of the transformer and the AC power source. A control terminal of the electric switch is coupled to an output terminal of the normal mode determination unit, and a switch terminal of the electric switch is coupled to the load.

### BRIEF DESCRIPTION OF THE DRAWINGS

FIG. 1 is a block diagram in accordance with the present invention;

FIG. 2 is a flow diagram of a determination procedure in accordance with the present invention; and

FIG. 3 is a block diagram of the conventional uninterruptible power supply (UPS) in accordance with the prior art.

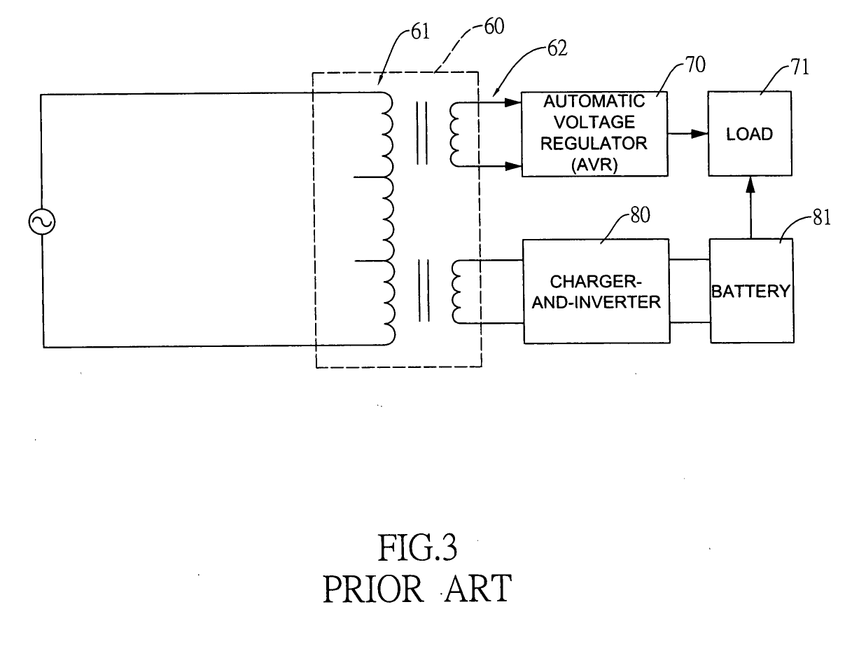

### DETAILED DESCRIPTION OF THE INVENTION

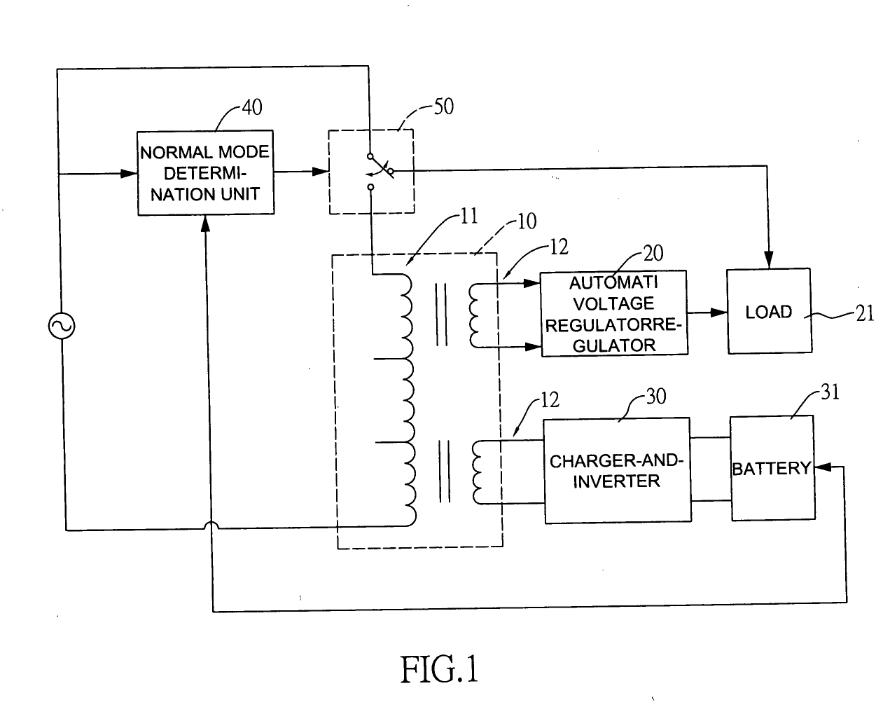

With reference to FIG. 1, a power saving uninterruptible power supply (UPS) in accordance with the present invention has a transformer 10, an automatic voltage regulator (AVR) 20, a charger-and-inverter 30, a normal mode determination unit 40 and an electric switch 50. The transformer 10 has a primary side 11 and a secondary side 12. The primary side 11 is coupled to an alternating current (AC) power source.

An alternating current (AC) input terminal of the AVR 20 is coupled to the secondary side 12 of the transformer 10 to acquire an inducted AC power source. Then the AVR 20 regulates the inducted AC power source to output to a load 21.

The charger-and-inverter 30 is coupled to the secondary side 12 of the transformer 10. Hence the charger-and-inverter 30 acquires a recharged power source to convert to a recharged current. Then the charger-and-inverter 30 charges the battery 31 or also converts electricity of the battery 31 to the AC power source to output to the transformer 10. Then the AVR 20 regulates the AC power source to provide an emergency power supply for the load 2.

The normal mode determination unit 40 is coupled to the AC power source and the battery 31. The normal mode determination unit 40 detects the power supply status of the AC power source and the battery capacity, so as to further determine whether current operation is normal.

The electric switch 50 is connected in serial to the load 21 and a power circuit of the transformer 10 and the AC power source. A control terminal of the electric switch 50 is coupled to an output terminal of the normal mode determination unit 40. A switch terminal of the electric switch 50 is coupled to the load 21. The electric switch 50 can be a relay, a MOS transistor or other electric devices that can be used as a switch.

The normal mode determination unit 40 has a microprocessor unit. Each input terminal of the microprocessor unit has an analog-to-digital converter. Hence analog signals of the detected AC power source and the battery capacity can be converted to corresponding digital detection signals. In this way, the microprocessor unit can determine whether the AC power source is normal and the battery capacity is sufficient.

If the AC power source is normal and the battery capacity is sufficient, the microprocessor unit determines that the operation status is in a normal operation mode. The microprocessor unit then controls the electric switch 50 that is connected in serial between the power circuit of the transformer 10 and the main power source to operate. That is to say, the microprocessor unit makes the electric switch 50 disconnect the main power source and the transformer 10, so as to make the main power source directly coupled to the load 21. In this way, a drawback that the load 21 acquires an operation power source via the transformer 10 and resulting in over-consuming the power in the normal operation mode can be effectively avoided.

On the contrary, if the microprocessor unit determines that the operation status is in an abnormal operation mode, the microprocessor unit controls the electric switch 50 to make the main power source coupled to the transformer 10. Hence the load 21 acquires the regulated power source via the AVR 20 and the transformer 10, or the charger-and-inverter 30 converts the battery capacity of the battery 31 to the regulated power source to provide to the load 21.

Furthermore, if the microprocessor unit determines that the battery capacity of the battery 31 is reducing, the microprocessor unit also immediately controls the electric switch 50 to make the main power source coupled to the transformer 10 to let the battery 31 acquire the recharged power source via the charger-and-inverter 30 and the transformer 10. Therefore, in this operation mode, the transformer 10 is fully used without over-consuming power.

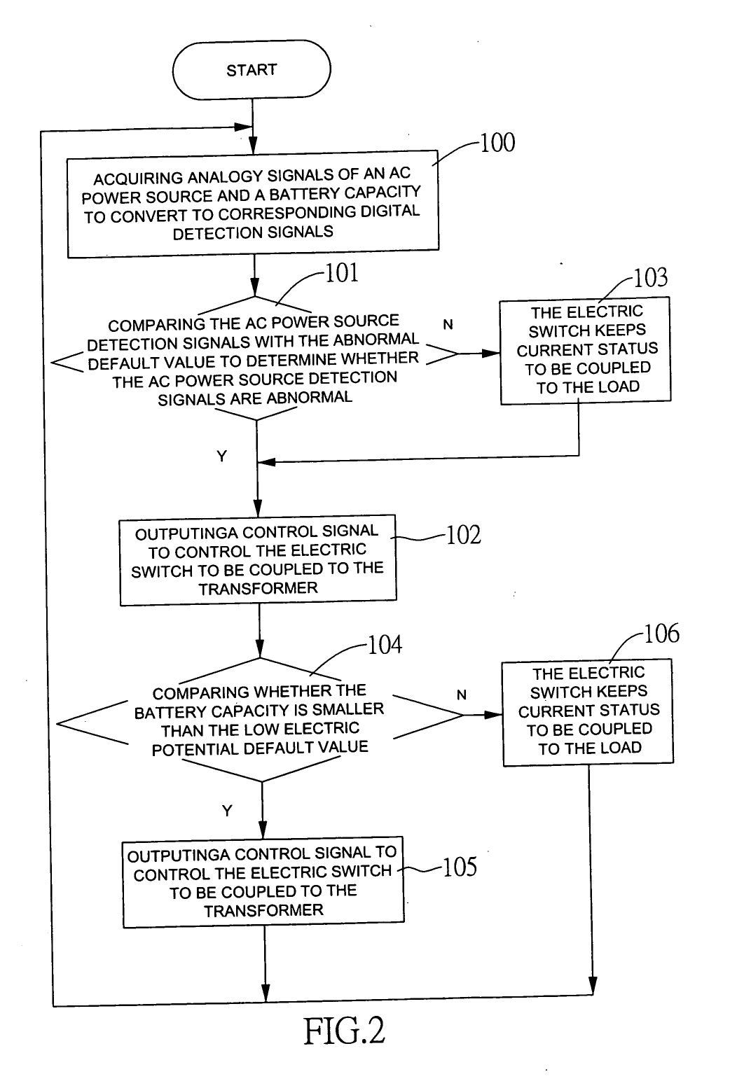

With reference to FIG. 2, a work flow diagram of a determination procedure of the microprocessor in accordance with the present invention is shown. The microprocessor has an abnormal default value and a low electric potential default value and also has a built-in determination procedure. The determination procedure has steps as follows.

A first step 100 is to acquire analog signals of an AC power source and a battery capacity to convert to corresponding digital detection signals.

A second step 101 is to compare the AC power source detection signals with the abnormal default value to determine whether the AC power source detection signals are abnormal.

If the AC power source detection signals are abnormal, the microprocessor unit outputs a control signal to control the electric switch to be coupled to the transformer as a third step 102. On the contrary, if the AC power source detection signals are normal, the electric switch keeps present status to be coupled to the load as a fourth step 103.

Next, a fifth step 104 is to compare whether the battery capacity is smaller than the low electric potential default value. If the battery capacity is smaller than the low electric potential default value, the microprocessor unit outputs the control signal to control the electric switch to be coupled to the transformer as a sixth step 105. On the contrary, if the battery capacity is not smaller than the low electric potential default value, the electric switch keeps present status to be coupled to the load as a seventh step 106. At last, the work flow returns to the first step.

Therefore, the present invention provides a solution to resolve the drawback of over-consuming the power when the uninterruptible power supply (UPS) is in the normal operation mode. In practical, the normal AC power supply time is usually longer than the abnormal or disconnected AC power supply time. To sum up, because the UPS is usually in the normal operation mode, the present invention indeed can effectively reduce the power consumption for the UPS, so as to achieve the objective to save the energy.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power saving uninterruptible power supply comprising:
a transformer having a primary side and a secondary side, wherein the primary side is coupled to an alternating current (AC) power source;
an automatic voltage regulator, wherein an alternating current input terminal of the AVR is coupled to the secondary side of the transformer to acquire an inducted AC power source, and then the AVR regulates the inducted AC power source to output to a load;
a charger-and-inverter coupled to the secondary side of the transformer to acquire a recharged power source to convert to a recharged current, and then the charger-and-inverter charges a battery;
a normal mode determination unit coupled to the AC power source and the battery to detect a power supply status of the AC power source and a battery capacity, so as to further determine whether current operation is in a normal mode; and
an electric switch connected in serial to the load and a power circuit of the transformer and the AC power source; wherein a control terminal of the electric switch is coupled to an output terminal of the normal mode determination unit, and a switch terminal of the electric switch is coupled to the load.

2. The power saving uninterruptible power supply as claimed in claim 1, wherein the normal mode determination unit comprises a microprocessor unit, wherein the microprocessor unit has a built-in determination procedure, wherein each input terminal of the microprocessor unit has an analog-to-digital converter to be coupled to the AC power source and the battery, so as to convert analog signals of the detected AC power source and the battery capacity to corresponding digital detection signals.

3. The power saving uninterruptible power supply as claimed in claim 1, wherein the electric switch can be a relay or a MOS transistor.

4. The power saving uninterruptible power supply as claimed in claim 2, wherein the electric switch can be a relay or a MOS transistor.

5. The power saving uninterruptible power supply as claimed in claim 2, wherein the microprocessor has an abnormal default value and a low electric potential default value, wherein the determination procedure comprises steps of:
a first step is to acquire analog signals of an AC power source and a battery capacity to convert to corresponding digital detection signals;
comparing the AC power source detection signals with the abnormal default value to determine whether the AC power source detection signals are abnormal; if the result is determined to be positive, the microprocessor unit outputs a control signal to control the electric switch to be coupled to the transformer; but if the result is determined to be negative, the electric switch keeps present status to be coupled to the load and then to execute a next step;
comparing whether the battery capacity is smaller than the low electric potential default value; if the battery capacity is smaller than the low electric potential default value, the microprocessor unit outputs the control signal to control the electric switch to be coupled to the transformer and then to return to the first step, but if the battery capacity is not smaller than the low electric potential default value, the electric switch keeps present status to be coupled to the load and then to return to the first step.

6. The power saving uninterruptible power supply as claimed in claim 5, wherein the electric switch can be a relay or a MOS transistor.
